(19) United States
(12) Patent Application Publication
(10) Pub. No.: US 2011/0033594 A1
(43) Pub. Date: Feb. 10, 2011

(54) Edible oil having excellent storage stability, and method for production thereof

(76) Inventors: Yoshihiro Murano, Kanagawa (JP); Tomoko Funabashi, Kanagawa (JP); Hiroyuki Takeuchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/736,550

(22) PCT Filed: Apr. 24, 2009
(86) PCT No.: PCT/JP2009/058129

§ 371 Date: Oct. 18, 2010

(30) Foreign Application Priority Data
Apr. 30, 2008 (JP) 2008-119284

(51) Int. Cl. C11B 5/00

(52) U.S. Cl. 426/541

(57) ABSTRACT

Disclosed is an edible oil which is hardly deteriorated by oxidation and therefore has excellent storage stability. Also disclosed is a method for producing the edible oil. A nitrogen gas in the form of nanobubbles each having a diameter of less than 1000 nm (1 μm) and microbubbles each having a diameter of 1 to 350 μm (inclusive) is added to an edible oil. In this manner, it becomes possible to produce an edible oil having a content of nitrogen in the oil or a content of dissolved nitrogen in the oil of 4.5% (by volume) or more and an edible oil containing nitrogen nanobubbles each having a diameter of less than 1000 nm (1 μm) and nitrogen microbubbles each having a diameter of 1 to 350 μm (inclusive).

### TECHNICAL FIELD

The present invention relates to an edible oil having excellent storage stability and a method for producing thereof, and particularly to an edible oil containing nitrogen in the form of nanobubbles and a method for producing thereof.

### BACKGROUND ART

Edible oils deteriorate by exposure to oxygen, heat, light and other causes. When an edible oil deteriorates, since the flavor of a food using this oil is degenerated, the deterioration of the edible oil needs to be suppressed.

As a means for suppressing degradation by oxidation caused by oxygen, among these causes, it is a general practice to add L-ascorbic acid and L-ascorbic acid derivatives, tocopherols, tea extract and other antioxidants.

Also disclosed is a method for preventing deterioration of oil by suppressing oxidation by inhibiting contact between the oil and oxygen comprising injecting an inert gas such as nitrogen into the oil, and mixing and dispersing the inert gas into the oil in a state that the inert gas is in the form of minute bubbles (10⁻⁵ to 10⁻⁷ cm=100 to 1 μm) in the oil, which improves the deoxidation action of oxygen in the oil (refer to patent Literature 1).

### PRIOR ART LITERATURE

### Patent Literature

Patent Literature 1: JP-A-2001-200288

### SUMMARY OF THE INVENTION

### Problem to be Solved by the Invention

As mentioned above, preventing deterioration of edible oils due to oxidation and improving its storage stability is an important problem from the perspective of maintaining good flavors of foodstuffs and other standpoints, and an excellent method for achieving it is required.

Therefore, an object of the present invention is to provide an edible oil having excellent storage stability whose deterioration by oxidation can be prevented, and a method for producing thereof.

### Means for Solving the Problem

To achieve the above object, the present invention provide an edible oil comprising nitrogen in an amount of 4.5% (by volume) or higher of the oil.

In addition, to achieve the above object, the present invention provides a method for producing an edible oil comprising: adding nitrogen gas in the form of nanobubbles having a diameter smaller than 1000 nm (1 μm) to the edible oil.

To achieve the above object, the present invention further provides a method for producing an edible oil wherein nitrogen gas is contained in an edible oil in the form of nanobubbles having a diameter smaller than 1000 nm (1 μm) and microbubbles having a diameter of 1 μm or larger but 350 μm or smaller.

To achieve the above object, the present invention further provides an edible oil containing nitrogen in the form of nanobubbles having a diameter smaller than 1000 nm (1 μm) (hereinafter referred to as nanobubble nitrogen).

### EFFECT OF THE INVENTION

According to the present invention, an edible oil having excellent storage stability whose deterioration by oxidation can be prevented, and a method for producing thereof can be provided.

### BRIEF DESCRIPTION OF THE DRAWINGS

FIG. 1 is a graph showing the measurement results of the distribution of the particle size of fine bubbles which is present in the edible oil of the present invention.

FIG. 2A is a graph showing the measurement results of Example 1 and Comparative Example 1, and FIG. 2B is a graph showing the measurement results of Example 2 and Comparative Example 2.

FIG. 3 is a graph showing the measurement results of Example 3 and Comparative Example 3.

### DETAILED DESCRIPTION OF THE EMBODIMENTS

### Edible Oil According to Embodiment of the Invention

In the edible oil according to an embodiment of the invention the amount of nitrogen contained in the oil is 4.5% (by volume) or higher. Preferably, the amount of nitrogen contained in the oil is 4.8% (by volume) or higher, and more preferably, the amount of nitrogen contained in the oil is 5.0% (by volume) or higher.

It is also preferable that the amount of nitrogen contained and dissolved in the oil is 4.5% (by volume) or higher, and it is more preferable that the amount of nitrogen contained and dissolved in the oil is 4.8% (by volume) or higher. Even more preferably, the amount of nitrogen contained and dissolved in the oil is 5.0% (by volume) or higher.

The amount of nitrogen contained in the oil is only the amount of nitrogen contained and dissolved in the oil in some cases, while it is the sum of the amount of nitrogen contained and dissolved in the oil and the amount of nitrogen contained but not dissolved in the oil in the other cases. Nitrogen not dissolved in the oil are contained, for example, in the form of bubbles such as nanobubbles and microbubbles.

The amount of nitrogen contained and dissolved in the oil is in some cases a numerical value measured, for example, after an oil and fat after an oil extraction step is subjected to a step of adding nitrogen, and is stored in an airtight metal container with no head space for seven days or longer. The oil and fat after an oil extraction step denotes an oil and fat which has undergone a mechanical expression step or a solvent extracting step, including an oil and fat which has undergone both steps (mechanical expression and solvent extracting step).

### Method for Producing Edible Oil According to Embodiment of the Invention

The edible oil according to an embodiment of the invention can be produced by adding nitrogen gas in the form of nanobubbles having a diameter smaller than 1000 nm (1 μm) to an oil and fat produced by a normal method.

In addition, the edible oil according to the embodiment of the invention can be produced by adding nitrogen gas in the form of nanobubbles having a diameter smaller than 1000 nm (1 μm) and microbubbles having a diameter of 1 μm or larger but 350 μm or smaller to an oil and fat produced by a normal method.

A method for turning nitrogen gas into nanobubbles and microbubbles is not particularly limited. Nanobubbles and microbubbles can be produced using a shearing device or by other means. Specific examples include a crashing method using vibration or shock waves such as ultrasound waves, a crashing method utilizing cavitation such as venturi tubes and others using flow rate differentials, a supersaturating separation method utilizing pressure dissolution, a shearing method utilizing venturi tubes, turning streams, rotary wings, or others, a micropore method utilizing SPG membranes or others, a solid embedding method, an electrolysis method, a chemical reaction method, a reduction method utilizing physical actions caused by pressurization, among others. These techniques may be used singly or in combination.

The amount of nitrogen gas, shearing time and other conditions are suitably adjusted so that the amount of nitrogen contained in the oil and the amount of nitrogen contained and dissolved in the oil fall within the above-mentioned range.

The edible oil produced by the above manufacturing method can be represented as an embodiment described below.

### Edible Oils According to Embodiment of the Invention

The edible oil according to the embodiment of the invention contains nitrogen in the form of nanobubbles having a diameter smaller than 1000 nm (1 μm).

### (Nanobubble Nitrogen)

In the embodiment of the invention, nanobubble nitrogen means nitrogen gas turned into fine bubbles (nano-size bubbles) having a diameter smaller than 1000 nm (1 μm). It is fine bubbles having a diameter of preferably 800 nm or smaller, more preferably of 50 nm or larger but 500 nm or smaller, and even more preferably of 100 nm or larger but 300 nm or smaller.

The amount of nanobubble nitrogen contained in the edible oil is not particularly limited, but is, for example, 0.1 to 1.5% (by volume) relative to the amount of nitrogen in the form of bubbles having a diameter of 200 μm or smaller contained in the edible oil immediately after the edible oil according to this embodiment is produced.

When a certain period of time elapses after the edible oil according to this embodiment is produced, a large part or all of the nanobubble nitrogen may not be confirmed in some cases. Therefore, the edible oil containing the nanobubble nitrogen according to the embodiment of the invention also includes an edible oil that used to contain nanobubble nitrogen, but can be no longer confirmed to contain nanobubble nitrogen after elapse of a certain period of time.

### (Microbubble Nitrogen)

The edible oil according to this embodiment preferably contains, along with nanobubble nitrogen, nitrogen in the form of microbubbles having a diameter of 1 μm or larger but 350 μm or smaller (nitrogen which is in the form of microbubbles is hereinafter referred to as microbubble nitrogen).

In the embodiment of the invention, microbubble nitrogen denotes nitrogen gas turned into fine bubbles having a diameter of 1 μm or larger but 350 μm or smaller. For example, the fine bubbles have a diameter of preferably 10 μm or larger but 300 μm or smaller, more preferably 10 μm or larger but 250 μm or smaller, and even more preferably 10 μm or larger but 200 μm or smaller.

The amount of microbubble nitrogen in the edible oil is not particularly limited, but is for example, 99.9 to 98.5% (by volume), relative to the amount of nitrogen in the form of bubbles having a diameter of 200 μm or smaller contained in the edible oil immediately after the edible oil according to this embodiment is produced.

A large part or all of microbubble nitrogen may not be confirmed in some cases when a certain period of time elapses after the edible oil according to this embodiment is produced. Therefore, the edible oil containing microbubble nitrogen according to the embodiment of the invention also includes an edible oil which used to contain microbubble nitrogen, but can be no longer confirmed to contain microbubble nitrogen after elapse of a certain period of time.

### (Edible Oil)

The kind of oils and fats which can be used as the edible oil according to this embodiment is not particularly limited. Examples include soybean oil, rapeseed oil, high-oleic rapeseed oil, corn oil, sesame oil, sesame salad oil, perilla (Perilla frutescens var. crispa) oil, linseed oil, peanut oil, safflower oil, high-oleic safflower oil, high-linolic sunflower oil, high-oleic sunflower oil, cotton seed oil, grape seed oil, macadamia nuts oil, hazelnut oil, pumpkin seed oil, walnut oil, camellia oil, tea seed oil, egoma (Perilla frutescens var. frutescens) oil, borage oil, olive oil, rice oil, rice bran oil, wheat germ oil, palm oil, palm kernel oil, coconut oil, cacao butter, beef tallow, lard, chicken fat, milk fat, fish oil, seal oil, algae oil, low-saturated oils of these oils and fats by breed improvement, and mixed, hydrogenated, or fractionated oil and fat thereof.

In addition, antioxidants such as L-ascorbic acid, L-ascorbic acid derivatives, vitamin E, tocopherols, fatty acid esters of ascorbic acid, lignan, coenzyme Q, phospholipid, oryzanol, plant sterol, diacylglycerol, catechins, polyphenols, tea extracts and other additives may be also added.

Examples of other additives include emulsifiers such as polyglycerol esters of fatty acids, sucrose esters of fatty acids, sorbitan esters of fatty acids, polysorbate, condensed ricinolate esters of fatty acids, monoglycerin fatty acid esters, soybean lecithin, egg yolk lecithin, soybean lysolecithin, egg yolk lysolecithin, enzyme-treated egg yolk, saponin, plant sterols, milk fat globule membrane.

### EFFECTS OF EMBODIMENT OF THE INVENTION

According to the embodiment of the invention, deterioration by oxidation can be prevented by adjusting the amount of nitrogen contained in the oil to be higher than a determined amount, and therefore an edible oil having excellent storage stability and a method for producing thereof can be provided. In addition, since the amount of oxygen dissolved in the edible oil can be reduced, an edible oil having excellent storage stability and a method for producing thereof can be provided.

Hereinafter, the present invention will be described with reference to Examples, but the present invention is not limited by these Examples.

### EXAMPLES

Nitrogen gas was injected to 800 g of a soybean sirasimeyu (refined soybean oil, trade name: Nisshin Daizu Sirasimeyu) manufactured by The Nisshin OilliO Group, Ltd. via a microbubble generator (manufactured and sold by FUKI CO., LTD., trade name: Nanostar) at a rate of 30 ml/min. for 20 minutes to produce nanobubble nitrogen and microbubble nitrogen by using the device and have them contained in the edible oil, producing an edible oil of the present invention.

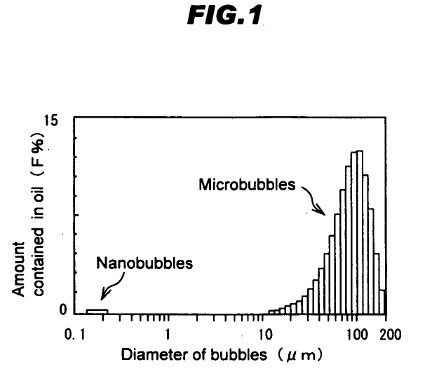

The edible oil produced was measured for its distribution of the particle size of fine bubbles having a diameter of 200 μm or smaller which were present in the edible oil after 30 to 40 seconds from production by using HORIBA LA-500 (batch type cell used). FIG. 1 is a graph showing the measurement results of the distribution of the particle size of fine bubbles which is present in the edible oil of the present invention.

### <Measurement Results> (% by Volume)

Nanobubble (145 to 220 nm): 0.6%

Microbubble (12 to 200 μm): 99.4%

### Examples 1 to 2

### Comparative Examples 1 to 2

Two 100 g portions of the edible oil of the present invention produced in the manner described above dispensed into a 250 ml medium bottle with no cap (Example 1), and a 250 ml medium bottle with a cap (Example 2), respectively, were prepared.

Meanwhile, an edible oil was produced by injecting nitrogen gas to 800 g of a soybean sirasimeyu (refined soybean oil, trade name: Nisshin Daizu Sirasimeyu) manufactured by The Nisshin OilliO Group, Ltd. by using a pipette at a rate of 30 ml/min. for 20 minutes. In a manner similar to that for the edible oil of the present invention, two 100 g portions of the edible oil produced dispensed into a 250 ml medium bottle with no cap (Comparative Example 1) and a 250 ml medium bottle with a cap (Comparative Example 2), respectively, were prepared.

The medium bottles of Examples 1 to 2 and Comparative Examples 1 to 2 were stored in an upright position in a dark place and an air atmosphere at 60° C. The peroxide values (POV) of the oils were determined by the method described below at day 0, day 4, day 6, day 8, day 10 and day 14 from production. As for the media bottles with a cap (Example 2, Comparative Example 2), the cap was opened and closed for a few seconds during measurement (during sampling).

### <Method for Measuring POV>

Measurement was carried out according to Standard Methods for the Analysis of Fats, Oils and Related Materials (refer to 2.4 Peroxide Value—Chloroform Method—).

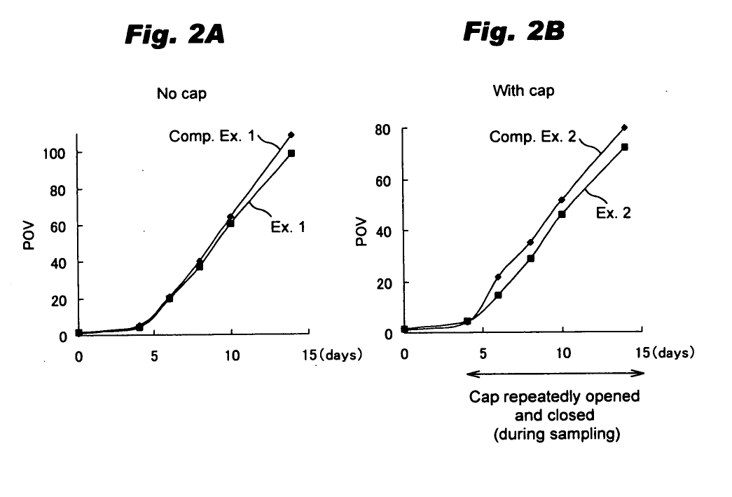

Measurement results of POV are shown in FIG. 2. FIG. 2A is a graph showing the measurement results of Example 1 and Comparative Example 1, and FIG. 2B is a graph showing the measurement results of Example 2 and Comparative Example 2.

As can be clearly seen from FIG. 2, in both states of storage with and without a cap, the edible oils of the present invention are more resistant to degradation by oxidation and excellent in storage stability compared with those of Comparative Examples.

### Example 3

### Comparative Example 3

30 g of the edible oil of the present invention produced in the manner described above dispensed into a 100 ml glass screw-cap vial bottle with a cap which can be tightly closed (Example 3) was prepared.

Meanwhile, in a manner similar to Comparative Examples 1 to 2, an edible oil was produced by injecting nitrogen gas thereinto by using a pipette. 30 g of the oil produced and dispensed into a 100 ml glass screw-cap vial bottle with a cap (Comparative Example 3) was prepared.

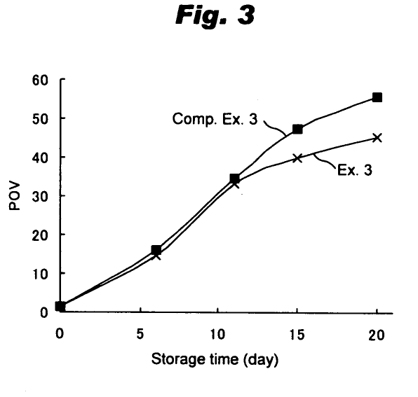

The glass screw-cap vial bottles of Example 3 and Comparative Example 3 were stored in an upright position in a dark place and an air atmosphere at 60° C., and the peroxide values (POV) of the oils were determined by the aforementioned method at day 0, day 6, day 11, day 15 and day 20 from production. Measurement results of POV are shown in FIG. 3.

As can be clearly seen from FIG. 3, the edible oils of the present invention are more resistant to degradation by oxidation and excellent in storage stability compared with Comparative Examples.

### Example 4

### Comparative Examples 4 to 5

A soybean sirasimeyu (refined soybean oil, trade name: Nisshin Daizu Sirasimeyu) manufactured by The Nisshin OilliO Group, Ltd. with no nitrogen gas injected thereinto (that is, untreated), the edible oils of the present invention produced in Examples described above and the edible oils of Comparative Examples were analyzed for their concentrations of dissolved gas according to a usual method for analysis of general insulating oils (industrial oils).

First, the untreated soybean sirasimeyu (Comparative Example 4), the edible oils of the present invention produced in Examples above (Example 4) and the edible oils of Comparative Examples (Comparative Example 5) were each hermetically sealed in an eighteen litre drum in a state that no head space was produced. The drums were stored in a refrigerator until the date of sample production. The drums were opened on day 72 from production, and the oils were dispensed. The temperatures of the edible oils were returned to room temperature after 4 days from dispensing, and samples were prepared in the following manner.

### (Preparation of Samples)

Each of the edible oils was dispensed into a 180 ml metal container all the way up to its opening (so that the oil overflows a little). Air in the container was pushed by pushing in a polyethylene inner lid so that bubbles do not get into the bottle. A metal screw cap was placed over the inner lid to hermetically seal the bottle. Two samples were prepared from each specimen.

### (Analysis)

On the day of preparation of the samples, the samples were transported by parcel delivery service at normal temperature to conduct analysis. The samples arrived on day 3 from the date of dispatch, were stored for seven days until the date of measurement at normal temperature, and were subjected to analysis on day 10 from preparation of samples.

### [Measurement Conditions]

Measuring equipment: (manufacturer, model number) Shimadzu Corporation GC-14

### Measurement Conditions

Carrier gas: helium

Column: Molecular Sieve 5A, inside diameter 3 mm×3 m, SUS column

Detector: TCD

Calculation method: Two-drum portions of samples were analyzed, and the average of the measurement values was calculated.

It should be noted that measurement of a standard gas was carried out prior to the analysis of the samples, and a correction factor for calculating their concentrations was determined.

Measurement results (results of analysis) are shown in Table 1 below.

TABLE 1
Measurement results(amount of gas contained
and dissolved in the oil, vol. %)

| | Comparative | Comparative | |
|---|---|---|---|
| | Example 4 | Example 5 | Example 4 |
| Nitrogen | 4.3 | 4.4 | 4.8 |
| Oxygen | 1.2 | 1.2 | 0.6 |

1. An edible oil comprising nitrogen in an amount of 4.5% (by volume) or higher of the edible oil.

2. The edible oil according to claim 1, wherein the amount of nitrogen contained and dissolved in the oil is 4.5% (by volume) or higher.

3. The edible oil according to claim 1, wherein the amount of nitrogen contained in the oil is 4.8% (by volume) or higher.

4. The edible oil according to claim 3, wherein the amount of nitrogen contained and dissolved in the oil is 4.8% (by volume) or higher.

5. A method for producing an edible oil, comprising: adding nitrogen gas in the form of nanobubbles having a diameter smaller than 1000 nm (1 μm) to the edible oil.

6. The method for producing the edible oil according to claim 5, wherein nitrogen gas is added in the form of said nanobubbles and microbubbles having a diameter of 1 μm or larger but 350 μm or smaller to the edible oil.

7. The method for producing the edible oil according to claim 5, wherein the amount of nitrogen contained in the oil is controlled to be 4.5% (by volume) or higher.

8. An edible oil comprising nitrogen in the form of nanobubbles having a diameter smaller than 1000 nm (1 μm).

9. The edible oil according to claim 8, the edible oil comprising nitrogen in the form of microbubbles having a diameter of 1 μm or larger but 350 μm or smaller.

10. The edible oil according to claim 2, wherein the amount of nitrogen contained in the oil is 4.8% (by volume) or higher.

11. The method for producing the edible oil according to claim 6, wherein the amount of nitrogen contained in the oil is controlled to be 4.5% (by volume) or higher.
